(19) United States
(12) Patent Application Publication
(10) Pub. No.: US 2002/0138729 A1
(43) Pub. Date: Sep. 26, 2002

(54) Management of an identity module

(75) Inventors: Jarmo Miettinen, Helsinki (FI); Jukka Liukkonen, Helsinki (FI); Marko Nordberg, Helsinki (FI)

Correspondence Address: COHEN, PONTANI, LIEBERMAN & PAVANE, Suite 1210, 551 Fifth Avenue, New York, NY, 10176, US

(73) Assignee: Sonera Smarttrust Oy

(21) Appl. No.: 09/977,669

(22) Filed: Oct. 15, 2001

(30) Foreign Application Priority Data
Apr. 15, 1999 (FI) 990846
Apr. 17, 2000 (FI) PCT/FI00/00328

(51) Int. Cl. H04L 9/00

(52) U.S. Cl. 713/173

(57) ABSTRACT

A method for the management of certificates stored on an identity module, wherein a certificate is received to the identity module, and information obtained from the certificate is stored on the identity module. The method makes it possible to increase the number of certificates that can be stored on the identity module.

### BACKGROUND OF THE INVENTION

1. Field of the Invention

The present invention relates to telecommunication systems and devices. In particular, the invention relates to a method for the management of an identity module and to an identity module which comprises means for the management of its storage areas.

The invention concerns a method for the management of certificates stored in an identity module. In the method, a certificate is received into the identity module, and information obtained from the certificate is stored on the identity module.

2. Description of the Related Art

Mobile communication networks, e.g. GSM networks (GSM, Global System for Mobile communications) have become very popular in recent times. Supplementary services associated with mobile communication networks are correspondingly increasing at an ever faster pace, in widely varying fields of application. The mobile telephone can be used, among other things, as a means of paying for small purchases e.g. in automatic vending machines for refreshment drinks and in automatic car wash systems. Everyday functions, such as payment functions, have been and will be added to the services available via mobile stations. Nextgeneration mobile stations will be considerably more advanced than their predecessors in respect of service level and data transmission capacity.

At present, a known practice is to use a digital GSM mobile station or other electronic and wireless terminal device having a unique identity for commercial transactions, such as paying a bill or remitting a payment by an electronic method. U.S. Pat. No. 5,221,838 discloses a device which can be used for remitting a payment. The specification describes an electronic payment system in which a terminal device capable of wireless and/or wired data transfer is used as a payment terminal. The terminal device according to the specification comprises a card reader, a keypad and a bar code reader for data input and a display for visual presentation of payment information.

U.S. Pat. No. 6,169,890 discloses a method for the utilization of telecommunication services and execution of payment transactions via a mobile communication system. The specification describes a system comprising a terminal device which communicates over a telecommunication network with a service provider's mainframe computer containing the service provider's payment system. The terminal device, i.e. mobile station used in the mobile communication network, can be provided with a subscriber identification unit which contains subscriber data for subscriber identification and encryption of telecommunication. The data can be read into the terminal device for use in mobile stations. As an example the specification mentions the GSM system, in which a subscriber identity module (SIM) or a SIM card is used as a subscriber identification unit.

In a system described in U.S. Pat. No. 6,169,890, a mobile station communicates with a base station in a mobile telephone network. According to the specification, a connection is further established from the base station to a payment system and the amount to be paid as well as the data needed for subscriber identification are transmitted to the payment system. In a bank service as described in the specification, the client inserts a bank service card containing a SIM unit into a terminal device of a GSM network. In the telephone based bank service, the terminal device may be a standard GSM mobile station. By the method described in the specification, a wireless telecommunication link can be used for implementing bank or cash services, such as remittance of payments and/or payment of bills or the like. It would also be possible to use some other terminal device as a payment terminal. An important point is that the terminal device contains or can be provided with an identity module having its own unique identity. It may also be a separate fail-safe circuit or equivalent.

A digital signature, which is considered a general requirement in electronic payment systems, is used for the verification of the integrity of the material transmitted and the origin of the sender. A digital signature is generated by encrypting a hash code computed from the material to be transmitted, using the senders secret key. As nobody else knows the sender's secret key, the receiver decrypting the material by using the sender's public key is able to ascertain that the material is unchanged and that it has been generated by the sender using his secret key known to himself. An example of an algorithm used for generating a digital signature is the RSA encryption algorithm, which is a public-and-secret-key encryption system and which is also used for the encryption of messages.

To make it possible to use uniform procedures for reliable identification of the parties to a transaction or other agreement via a telecommunication network, it is necessary to have an electronic identity and means for proving and ascertaining the identity. An electronic identity like this may also be e.g. a so-called network identity (Net-ID). An electronic identity is based on personal data stored on a smart card, subscriber identity module, electronic failsafe circuit or equivalent and the use of a key pair, a secret key and a public key, stored in a certificates directory maintained by a trusted third party. Using such a technique, it is possible to implement, among other things, the identification of parties, electronic signature, encryption and indisputability of transactions, in a manner providing a security level sufficient for the authorities and other service providers.

In the present application, ‘identity’ refers to individualizing information which is attached to a person or a juridical person holding an identity and which can be used to identify the person or holder. Likewise, ‘identity’ may refer to individualizing information pertaining to an application or service and allowing the application or service to be identified.

In a public key method, the user keeps a secret key in private use only while a public key is publicly available. Storing the public key as such in a public directory, e.g. in a x. 500 or LDAP directory, is not enough because someone might forge it and then act in the name of the rightful owner of the key. Instead, it is necessary to have a certification service and a certificate, which means an evidence given by a trusted third party (certifier) vouching that the name, the personal identifier and the public key belong to the same person. The certificate is generally a data aggregate consisting of the person's public key, name, personal identification number and other information, and it is signed by the certifier using his own secret key.

When the receiver of a message provided with an electronic signature wants to ascertain whether the message is an authentic one, he must first get the sender's certificate, from which he will learn the sender's public key and name. After this, he must verify the authenticity of the certificate. To this end, he may have to obtain additional certificates (certification chain) which have been used to certify the certificate in question.

If the certificate is authentic, the receiver verifies the signature of the message by using the public key received in the sender's certificate. If the signature passes this test, then the sender is the person indicated by the certificate. The use of certificates also necessitates the use of a freeze file in which discarded certificates are listed. For the certificates and the freeze file, directory services are needed.

When different applications used for electronic payment, commercial transactions, banking etc. are stored on the identity module, the public keys used in the services provided by service providers, such as stores, banks and other organizations providing electronic services, used by these applications are stored at the same time. Public keys can also be stored later depending on the services used by the user of the subscriber identity module. Thus, the user of the identity module need not obtain a certificate for each transaction separately as the certificate is already on the identity module.

The longer the certification chain created to produce a certificate, the more information is needed for the verification of the certificate. Certificates requiring a large amount of memory are a problem to current identity modules because the identity module often has a limited memory space. This is a significant factor limiting the use of the identity module for different services having different certificates. Therefore, it is an urgent objective to reduce the size of the certificate to allow a larger number of certificates to be stored on a single identity module. A given service application may use several certificates when communicating on the user's behalf with the services of different service providers. Thus, the number of different services usable via the identity module is almost exclusively limited by the size of the certificates.

### OBJECTS AND SUMMARY OF THE INVENTION

The object of the present invention is to eliminate the problems referred to above or at least to significantly alleviate them. A specific object of the invention is to disclose a method and an identity module that will make it possible to define the size of a certificate or at least to reduce it, thus allowing the number of certificates stored on a single identity module for use in a mobile communication environment to be increased.

A further object of the invention is to disclose a method whereby a larger number of certificates than before can be stored on the identity module without breaking the reliability chain in a chain of certificates.

The main principle of operation of the solution of the invention is to store the required certificates on the identity module so that the certificates comprised in a certification chain are removed from them. The identity module may be a SIM (Subscriber Identity Module), a WIM (Wireless Identity Module), a security module or a corresponding separate fail-safe circuit or a similar device or component used to manifest identity. The identity module may be a fixed or a detachable component and it must be manageable by the owner of the identity. A certificate received on the identity module may be saved if it can be authenticated using a card certificate stored on the identity module. After the certification chain has been removed, the remaining public key and the associated identity are stored in a protected storage area to which no access is allowed for any other applications than the application used by the card certificate. Every time when a service application in the identity module wants to use a certificate stored on the card, it requests it from the application used by the card certificate from the protected storage area. The application used by the card certificate verifies the certificate read from the protected storage area and when the user trusts the issuer of the card certificate, the user can also trust the certificate read from the card.

The basic idea of the invention can be expressed in a nutshell as follows. A functional unit has been divided into two sections A and B and a condition C. The functional unit may be the storage device or memory of the identity module and the condition C may be a filter or algorithm controlling the storage space. The function of section A is a known, open memory area and its functionalities can be influenced by known instructions, the operating system of the identity module. Section B may function in the same way as A, but the functionalities of B may only be used by a party who knows the conditions C. In the present case, the condition C is only known to the certification authority D issuing the card certificate and to the filter or algorithm on the card which controls the protected storage area.

When a new certificate is to be stored on the identity module, the deliverer of the new certificate asks a certification authority D to store the certificate on the identity module. Certification authority D authenticates the new certificate received from another certification authority E and selects from the certificate only those components F which necessarily have to be stored on the identity module.

Certification authority D generates his own certificate G from the new certificate given by E and from the selected components F. Appropriate information about certificate G needed to make it possible to read from which certificate the material F has been generated and to establish that the material has been certified by certification authority D is filed in the directory. Since only certification authority D knows the conditions regarding the manner in which F is to be disposed in the protected area B, F can be regarded as a certificate that is not public and that can be trusted.

In the method of the invention for the management of certificates stored on the identity module, the certificate is received to the identity module and information about the certificate is stored on the identity module. The identity module includes a storage device of a data processing apparatus, the storage device being connected to the processing apparatus, a card certificate stored on the storage device, an application which uses the certificates stored on the identity module, and a data transfer device connected to said data processing apparatus and provided with a communication interface for the transfer of data between an external device, such as a mobile station, and the identity module.

According to the invention, the authenticity of the certificate is verified by means of the card certificate before the certificate is stored, and the certification chain contained in the authenticated certificate is filtered out from it. Before the filtering, each signature and certificate included in the certification chain can be additionally verified separately if necessary. After the filtering, the portion of the certificate remaining to be stored comprises the public key contained in it and the identity associated with it, but other information may be stored as well. In this way, the amount of storage space occupied by the certificate can be significantly reduced. When the certificate is to be used, it must first be verified by means of the card certificate.

In an embodiment of the invention, the certificate is rejected if a verification carried out before its storage or use indicates that the certificate is unreliable. In addition, when reliable means and software are used, the certificates and the transactions implemented using them can be trusted. However, we wish to point out here that, if the card certificate is rejected, this does not necessarily mean that the certificate could not be used by an application on the card. Thus, if any one of the applications identifies the certificate, then it can be stored on the identity module. The only difference to the filtered certificate is that the certificate is stored in its complete form without filtering out anything from it.

The identity module of the invention for the management of certificates includes the above-mentioned components. Moreover, the identity module includes means for receiving a certificate to the identity module and means for saving information contained in the certificate to a storage device.

According to the invention, the identity module includes means for verifying the authenticity of the certificate by means of the card certificate before the storage of the certificate and means for filtering out a certification chain contained in the authenticated certificate from the certificate. Furthermore, the identity module includes means for verifying the certificate by means of the card certificate before its use.

In an embodiment of the invention, the identity module further includes means for rejecting the certificate if a verification carried out before its storage indicates that it is unreliable, and means for rejecting the certificate if a verification carried out before its use indicates that it is unreliable. Moreover, the identity module may include means for verifying the authenticity of each signature contained in the certificate before the filtering.

As compared with prior art, the present invention has the advantage that a larger number of certificates than before can be accommodated in a limited storage space. In particular, the invention allows a larger number of certificates to be stored on the identity module or on a smart card.

A further advantage of the invention as compared with prior art is that an update of the identity module with new certificates and applications can be certified by the certification method of the invention using a card certificate.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a diagrammatic representation of an identity module according to the present invention;

FIG. 2 is a diagrammatic representation of a method according to the present invention for storing a certificate on an identity module; and

FIG. 3 is a diagrammatic representation of a message structure which can be used in the method of the present invention.

### DETAILED DESCRIPTION OF THE PRESENTLY PREFERRED EMBODIMENTS

In the following, the invention will be described by the aid of a few examples of its embodiments with reference to the drawings.

Although the invention is described in the following examples by referring to a subscriber identity module, it can be applied in conjunction with any terminal device that uses identity modules as mentioned above. The invention is not limited to GSM network subscriber identity modules.

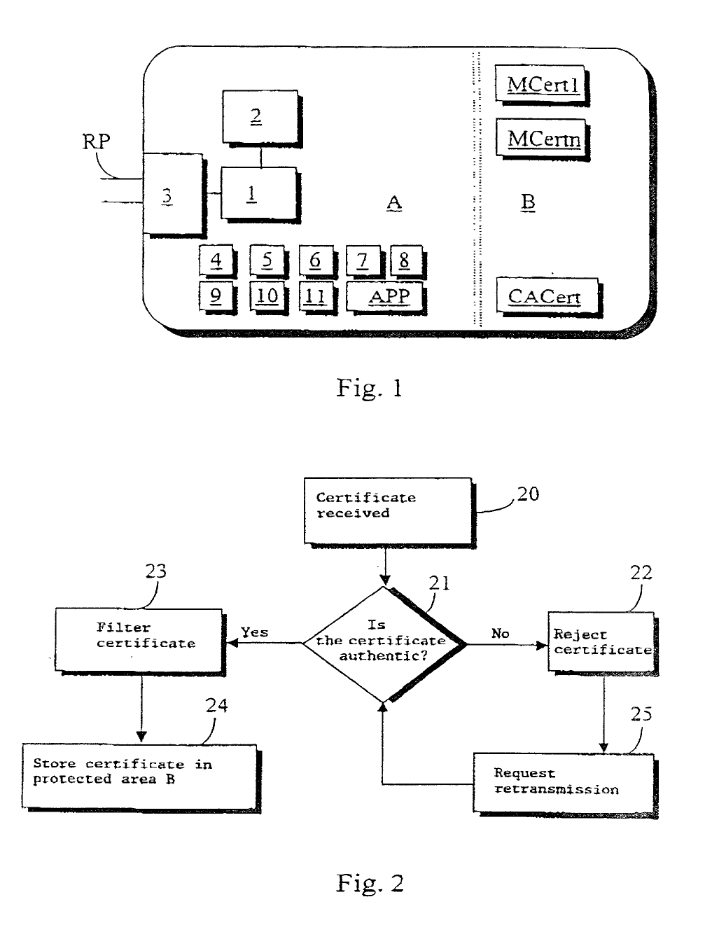

The subscriber identity module (SIM) presented in FIG. 1 comprises a data processing device 1, such as processor, microcontroller or equivalent, a storage device 2 connected to the data processing device 1 and a data transfer device 3 connected to the data processing device 1. Moreover, the subscriber identity module SIM is provided with a communication interface IF for data transfer between an external device, such as a GSM mobile station, and the subscriber identity module.

In addition, the subscriber identity module presented in FIG. 1 comprises an application APP or contains an application APP stored on it, which application uses certificates stored on the subscriber identity module when communicating with services provided by a service provider. Furthermore, the subscriber identity module is provided with means 4 for receiving certificates and means 5 for saving information obtained from the certificate to the storage device 2. Moreover, the subscriber identity module comprises means 6 for establishing the authenticity of a received certificate by using a card certificate (CACert) as mentioned above and means 7 for filtering out from an authenticated certificate a certification chain contained in it before the storage of the certificate.

Further, the subscriber identity module presented in FIG. 1 comprises means 8 for authenticating a certificate Mcert_1 stored on the subscriber identity module by means of a card certificate CA_Cert before its use. In addition, the subscriber identity module comprises means 9 for rejecting a certificate if a verification carried out before storage indicates that the certificate is unreliable, and means 10 for rejecting a certificate if a verification carried out before use indicates that the certificate is unreliable. Furthermore, the subscriber identity module comprises means 11 for authenticating the signature contained in each of the certificates before the filtering out of the signature.

In addition, referring to the above example, FIG. 1 shows areas A and B, which, as mentioned above, are a non-protected storage area A and a protected storage area B. In the protected storage area is stored at least the card certificate Card_CA, which comprises the card certificate issuer's electronic or network identity, a short name description of the certification authority, certificate type, e.g. RSA, a public encryption key, a public signing key, certificate status, i.e. data indicating whether the certificate is active or passive, and the number of the short message service center, the number referring to the issuer of the certificate. Stored in the protected storage area is also the user's own certificate, which, by way of example, may include the same data items as described above in conjunction with the card certificate except that the public encryption key and public signing key are replaced with a secret encryption key and a secret signing key, respectively. The user's certificate is referred to in this example by the term M_Cert-1. In addition, service providers' certificates, from which the certifying signatures have been removed to reduce the storage space occupied by them, may be stored in the protected storage area B. These certificates are referred to by the designation Mcert_n. These certificates, too, preferably contain the same data items as the card certificate.

Next, referring to FIG. 2, a preferred procedure used for receiving a certificate to the subscriber identity module will be described. First, the certificate is received to the subscriber identity module, block 20. The certificate has been authenticated by the issuer of the card certificate, and this is verified in block 21. If it is found that the authenticity of the received certificate cannot be established even with the card certificate Card_CA stored on a card, then the certificate is rejected. The procedure could alternatively be terminated at this point (block 22), but in this example we can assume that retransmission of the certificate is requested, block 25, whereupon the certificate is verified again. This may be repeated e.g. three times, and if even the third attempt fails to prove the certificate to be authentic, then the procedure is terminated.

If it was established in block 21 that the certificate is authentic, then the entire certification chain is filtered out from the certificate, leaving only the public key and the associated identity and possibly some additional data, block 23. After this, the filtered certificate is saved, block 24, to the protected filtered storage area B in the subscriber identity module.

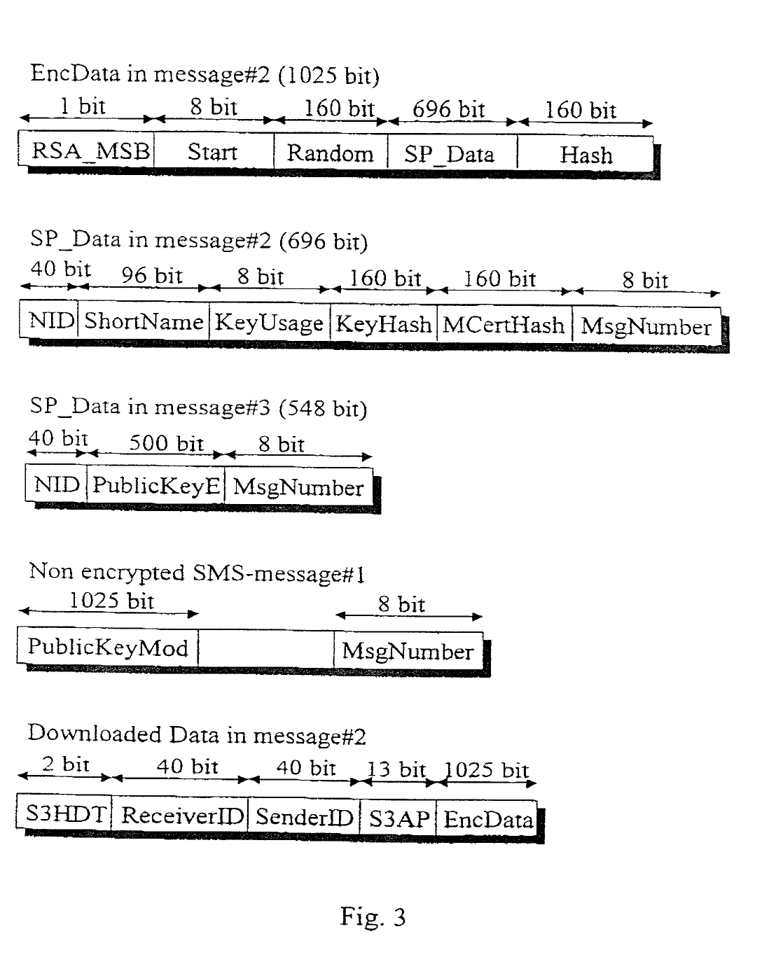

Next, referring to FIG. 3, a few preferred message structures will be described which can be used for the transmission of certificates according to the invention via an air interface to the subscriber identity module. In this example it is assumed that the message type used is short message (Short Message Service, SMS), but, as is obvious to the skilled person, other message types could be used as well. In this example, the certificate is transmitted using three short messages containing information as presented in FIG. 3.

The first message to be sent is a nonencrypted SMS message #1 comprising two fields. PublicKeyMod is a public verification or encryption key. In addition, the message contains the sequence number of the message, MsgNumber. The total length of this message is 1033 bits, of which the public key takes up 1025 bits and the message number 8 bits. The second message, Downloaded Data in message #2, comprises five fields. S3 HDT describes the message type, ReceiverID the identity of the receiver, SenderID the identity of the sender, where the identity may be e.g. a network identity code, S3AP is a pointer referring to an application which uses the certificate in question, and in addition the message comprises an RSA block, ENCDATA, which by default consists of signed and encrypted data. The size of this message is 1120 bits.

The signed and encrypted data, ENCDATA, in the message comprises five fields, the first one of which contains the most significant bit RSA_MSB of the RSA, a start field Start, the root Random of a random number, transmitted data SP_data and a hash code Hash generated from the contents of the SP_data field. The hash code is used to verify the integrity of the information and to ensure that the information has not changed during the transmission. Further, SP_data in message #2 comprises eight fields, of which the first one, NID, refers to the identity of the card certificate, ShortName refers to the name of the key holder, KeyUsage to the intended use of the key, KeyHash to a hash code generated from message number 1, MCertHash to a hash code generated from the certificate, and a message number, MSG Number. Finally, a third message is sent, which further is part of the SP_data field of message 2 ENCDATA, this field further containing a pointer to the key pair NID of the issuer of the card certificate, the exponent PublicKeyE of the public key and the sequence number MsgNumber of the message. We wish to point out further that the above description of message structures is not to be taken as a limitation but rather as an example of the application of the invention. In the verification of the authenticity of a certificate received to the subscriber identity module, the above-described hash codes are used. By means of these, it is possible to make sure that the received certificate has been signed and authenticated by a given predetermined certification authority or certificate issuer. After it has been established that the certificate is authentic, the public key and the associated identity can be picked out or filtered from it and stored in the filtered area B.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. Method for the management of certificates stored on an identity module, said method comprising:
providing an identity module comprising a data processing device, a storage device connected to said data processing device, a card certificate stored on the storage device, an application which uses the certificates stored on the identity module, and a data transfer device which is connected to said data processing device and which is provided with a communication interface for the transfer of information between an external device and the identity module,
receiving a certificate to the identity module;
authenticating said certificate by means of said card certificate; and
storing information obtained from said authenticated certificate on said storage device.

2. Method according to claim 1, further comprising filtering said authenticated certificate to remove a certification chain contained in said authenticated certificate.

3. Method according to claim 1, wherein said certificate is authenticated by means of the card certificate before its use.

4. Method according to claim 1, wherein said stored information comprises a public key and an associated identity.

5. Method according to claim 1, further comprising verifying whether said certificate is authentic prior to storage, and when authenticity cannot be verified, rejecting said certificate.

6. Method according to claim 1, further comprising verifying whether said certificate is authentic before its use, and when authenticity cannot be verified, rejecting said certificate.

7. Method according to claim 2, wherein the filtering comprises verifying whether each signature in said certificate is authentic, and filtering out only signatures that the verification proves to be authentic.

8. Identity module for the management of certificates, said identity module comprising:
a data processing device;
a storage device connected to said data processing device;
a card certificate stored on the storage device;
an application which uses certificates;
a data transfer device, which is connected to said data processing device and which is provided with a communication interface for the transfer of information between an external device and the identity module;
means for receiving a certificate to the identity module;
means for authenticating said certificate by means of said card certificate; and
means for storing information contained in said authenticated certificate on said storage device.

9. Identity module according to claim 8, wherein the identity module further comprises:
means for filtering out from the certificate a certification chain contained in said authenticated certificate.

10. Identity module according to claim 8, wherein the identity module further comprises means for establishing the authenticity of said certificate by means of a card certificate before its use.

11. Identity module according to claim 8, wherein the identity module further comprises:
means for verifying whether said certificate is authentic prior to storage indicates that it its unreliable; and
means for rejecting said certificate when authenticity cannot be verified.

12. Identity module according to claim 8, wherein the identity module further comprises:
means for verifying whether said certificate is authentic prior to use; and
means for rejecting said certificate when authenticity cannot be verified.

13. Identity module according to claim 9, wherein the identity module further comprises means for verifying the authenticity of each signature contained in said certificate before filtering.
